(19) United States
(12) Patent Application Publication
(10) Pub. No.: US 2026/0095723 A1
(43) Pub. Date: Apr. 2, 2026

(54) METHOD, DEVICE, AND SYSTEM FOR LOCATION AWARENESS APPLICATION MANAGEMENT

(71) Applicant: Michelle RUAN, Naperville, IL (US)

(72) Inventor: Michelle RUAN, Naperville, IL (US)

(21) Appl. No.: 18/904,015

(22) Filed: Oct. 1, 2024

(51) Int. Cl. H04W 4/029

(52) U.S. Cl. CPC H04W 4/029

(57) ABSTRACT

Methods, terminal (device), and computer readable storage medium for managing applications (apps) in a terminal. One method includes determining a current location information indicating a current location of the terminal; determining, based on the current location information, a candidate app installed in the terminal, wherein an applicable location of the app matches the current location, and wherein the candidate app is a candidate to be selected by a user of the terminal; and adding the candidate app to a special app folder which is created in the terminal.

### FIELD OF THE TECHNOLOGY

This disclosure relates to the field of computer and electronic technologies, and in particular, to a method, device, and system for location awareness application management.

### BACKGROUND OF THE DISCLOSURE

As internet technologies continually develop, smartphone applications (APPs) have profoundly transformed daily lives, becoming indispensable tools for communication, productivity, entertainment, and information access. These apps have revolutionized how we manage our daily activities, such as shopping, banking, interacting with friends, family, and community, driving, and entertaining. Smartphone apps make services more accessible, allowing us to shop, book transportation, or access various activities with just a few taps. Apps influence our habits, from how we shop and socialize, to how we learn new skills and stay informed about the world. Developing a device and system that supports easy app navigation is crucial.

### SUMMARY

An embodiment of this disclosure provides a method for managing applications (apps) installed in a terminal, performed by the terminal, the method including:
determining a current location information indicating a current location of the terminal;
determining, based on the current location information, a candidate app installed in the terminal, wherein an applicable location of the app matches the current location, and wherein the candidate app is a candidate to be selected by a user of the terminal; and
adding the candidate app to a special app folder which is created in the terminal.

Another embodiment of this disclosure further provides a terminal, including a memory and a processor, the memory storing computer-readable instructions, the instructions cause the processor to perform the operations of the method for managing applications described above.

Another embodiment of this disclosure further provides a non-transitory storage medium, storing processor executable instructions, the instructions, when executed by one or more processors, implement the method for managing applications described above.

### BRIEF DESCRIPTION OF THE DRAWINGS

FIG. 1 shows an exemplary terminal installed with multiple applications (apps) and application folders according to an embodiment of this disclosure.

FIG. 2 shows an exemplary application folder for organizing multiple apps.

FIG. 3 shows an exemplary special app folder for dynamically organizing multiple apps based on current location information according to an embodiment of this disclosure.

FIG. 4 shows a schematic flowchart of a method for dynamically managing and organizing apps installed in a terminal according to an embodiment of this disclosure.

FIG. 5 shows another exemplary special app folder for dynamically organizing multiple apps based on current location information according to an embodiment of this disclosure.

FIG. 6 is a schematic structural diagram of an apparatus or a terminal for managing applications according to an embodiment of this disclosure.

### DESCRIPTION OF EMBODIMENTS

Smartphone apps have become an integral part of modern life, profoundly changing how people interact with the world around them. These digital tools have transformed various aspects of human daily routines, such as retail, financial management, fitness, leisure, social interaction, personal wellness, and so on.

E-commerce apps, including shopping apps and reward/loyalty apps, are a significant subset of smartphone apps. For example, many shopping apps allow users to browse products, apply discounts such as coupons, and make purchases directly through the app. They often include features like personalized recommendations based on browsing history, wish lists for future purchases, and real-time notifications for sales or restocks. Some apps also incorporate augmented reality technology, enabling users to virtually “try on” clothes or visualize furniture in their homes before buying.

Reward apps, often integrated with shopping apps, offer reward points, cashback, or other incentives for making purchases through the app or at partnered stores. Users can accumulate these rewards over time and redeem them for discounts, gift cards, or even cash. Some apps also gamify the shopping experience, offering additional bonuses for completing certain tasks or reaching spending milestones. For example, a coffee shop reward app may feature a three-day challenge, wherein customers who make purchases on three consecutive days are rewarded with a bonus, such as a complimentary beverage.

Many retailers have developed their own apps that combine shopping functionality with loyalty programs. These apps often provide exclusive deals to app users, early access to sales, and personalized offers based on the customer's shopping history. They may also include features like digital receipts, easy returns, and in-store navigation to enhance the overall shopping experience.

The use of these apps has transformed how people approach shopping, encouraging more frequent engagement with brands and providing a more tailored, and rewarding experience. The convenience and potential savings offered by shopping and reward apps continue to drive their popularity among consumers.

Given the numerous advantages offered by smartphone apps, it is understandable that users are increasingly installing a wider variety of apps on their devices. The proliferation of these digital tools on smartphones reflects their growing utility and integration into daily life.

However, despite the trend towards larger screens, smartphones still offer relatively small screen sizes, which makes categorizing, arranging, and locating numerous apps challenging and time-consuming.

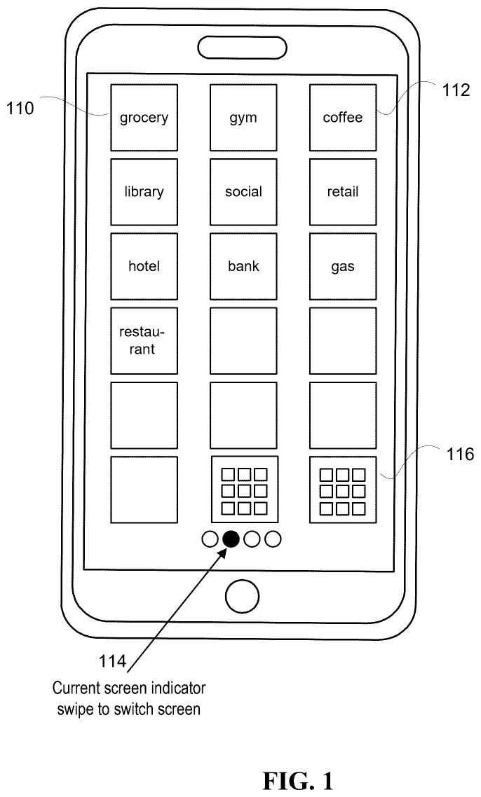

FIG. 1 shows an example screen of a terminal (such as a smartphone) for managing and navigating various apps. Displayed in the screen, each square icon represents an app, or an app folder used for organizing apps. For example, there is a grocery app 110 (for a grocery store), and a coffee app 112 (for a coffee shop). There are other apps, including apps for gyms, libraries, retail shops, hotels, banks, gas stations, and restaurants.

The square icon may also represent an app folder for grouping apps. For example, square icon 116 encompasses a group of apps. Multiple apps may be consolidated or classified into a specific group according to certain criteria, such as their functional characteristics. To access the applications within this group, a user may open an app folder, which includes one or more apps, by clicking the icon 116.

A single device, such as a smartphone, may incorporate multiple screens for managing and displaying application icons. As illustrated in FIG. 1, the presence of four small dots at the screen's bottom edge denotes the existence of multiple app management screens, specifically four in this case. The second dot from the left, represented by 114 and displayed as solid black, signifies that the user is presently viewing the second screen.

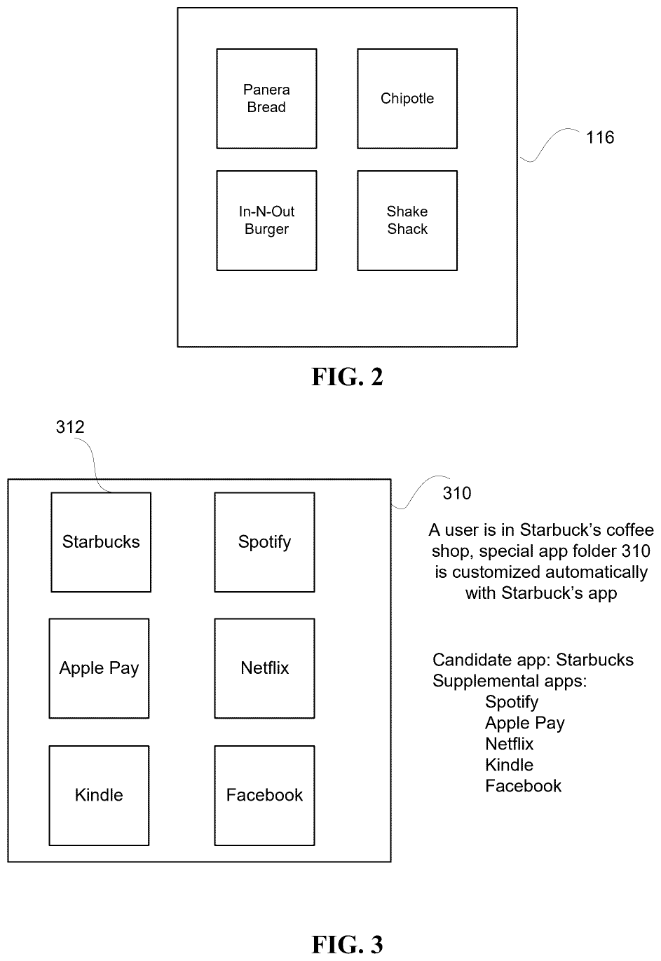

FIG. 2 illustrates an exemplary folder designated for organizing restaurant-related apps. This folder becomes accessible when a user interacts with the square icon 116 through a clicking action. As shown in FIG. 2, the folder encompasses several restaurant applications, specifically including apps for Panera Bread, Chipotle, In-N-Out Burger, and Shake Shack.

As smartphones evolve, their capabilities expand, leading users to rely on an ever-increasing number of apps for various aspects of their lives. From shopping apps to entertainment, social, and health tracking apps, the average smartphone now hosts dozens, if not hundreds, of applications. This proliferation creates a pressing need for efficient application organization for several reasons:
1. Accessibility: Users need quick access to apps without searching through multiple screens or folders.
2. Efficiency: Well-organized apps can significantly reduce the time spent searching for specific applications, enhancing overall efficiency and productivity.
3. Cognitive load reduction: A cluttered app layout can be overwhelming and stressful, making it difficult to focus on essential tasks.
4. Customization and personalization: Effective app organization allows users to tailor their smartphone experience to their specific needs and preferences.

Despite the clear benefits of app organization, users face numerous challenges when attempting to create an efficient one.

In one aspect, smartphone screens, despite growing larger, still offer limited space for app icons, making it difficult to display all apps simultaneously.

In another aspect, with millions of apps available across various categories, users often struggle to create coherent groupings that make sense for their usage patterns.

In another aspect, user's needs may change over time, therefore maintaining an optimal app organization becomes an ongoing process rather than a one-time task.

In yet another aspect, a folder, which acts as a container for one or more apps, may have its own limitations. For example, there may exist many app folders, and a folder may hide apps from immediate view, necessitating that users recall the specific folder containing a desired app. This memory requirement may introduce an additional cognitive burden for users navigating their device.

In this disclosure, various embodiments are described, with the goal of enabling quick app navigation and discovery and improving user experience when using the terminal, which may be based on, for example, location information of a current location where the terminal is located.

In some embodiments, a special app folder is created on a terminal (e.g., a smartphone), which is different from a traditional app folder (such as the folder 116 shown in FIGS. 1 and 2). The traditional folder is a static folder, in the sense that the folder has to be created by a user, and the folder is populated with user selected apps (e.g., by manually dragging apps into the folder). Once the user creates and/or updates a static folder, the content (i.e., apps) inside the folder is static, until the next manual update. In contrast, the apps in the special folder are populated dynamically and automatically based on location information.

As an example, assume a user has multiple apps for multiple coffee shops installed in the smartphone, and these apps may include, for example, a Starbucks app, a Peet's coffee app, and a Blue Bottle coffee app. When the user is not in (or near) any of these coffee shops, the special app folder does not contain any of these coffee shop apps. However, as shown in FIG. 3, once the user enters a Starbucks store, the Starbucks app will be populated in the special app folder 310. The user may easily locate the special folder, to access the Starbucks app for ordering and/or payment. Once the user exits the Starbucks store, the Starbucks app will be removed from the special app folder 310. Similarly, once the user enters a Peet's coffee shop, the Peet's coffee app will be populated in the special app. Therefore, the special folder is automatically customized based on the user's location (or the smartphone's location). In this disclosure, a special app folder may also be referred to as a smart folder, or a location awareness folder.

In some example implementations, the special app folder may be positioned in a readily accessible spot, such as a predetermined area on the initial screen displayed immediately after unlocking the smartphone. In some example implementations, a user may choose his/her preferred location for the special app folder. By positioning the special app folder in a visually prominent location, the user may quickly locate it immediately upon unlocking the smartphone's screen. Further, by dynamically and automatically populating app(s) that is/are relevant to the location, the user may effortlessly locate the required app(s) which may be used at the current location.

Detailed descriptions are provided below.

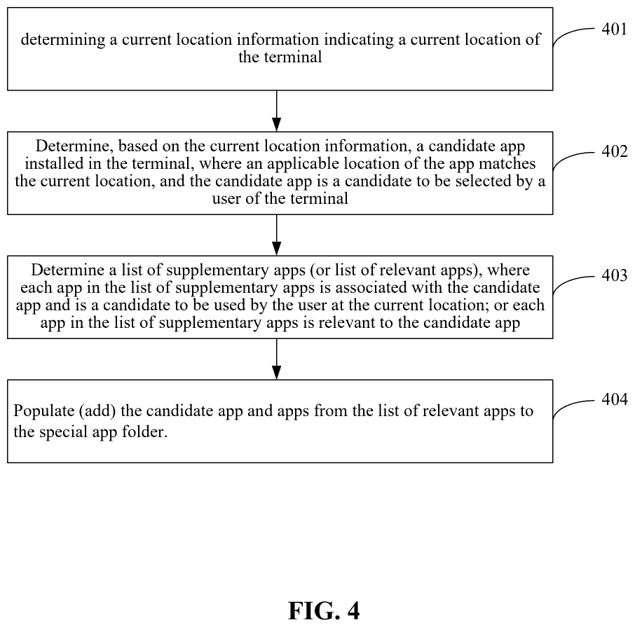

This embodiment is described from the perspective of a terminal/computer device, such as a smartphone, a tablet, a laptop, and the like. Such terminal/computer device has the capability to install and run apps. Referring to FIG. 4, a method of this embodiment, executed by a terminal (e.g., a smartphone), may include the following steps:

401. Determine a current location information indicating a current location of the terminal by, for example, a Global Positioning System (GPS). The GPS may be integrated in the terminal.

In this embodiment, the current location of the terminal may be acquired by the GPS. The positioning system may also include GLONASS, Galileo, and BeiDou. Alternatively, other types of positioning, such as Wi-Fi positioning, positioning using a cellular network, and Assisted GPS (A-GPS) which combines GPS with cellular network resources to improve positioning speed and accuracy.

In some example implementations, the determination of the current location may be triggered by a user instruction. For example, the user may interact with the terminal to request a determination of the current location information. The interaction may include, for example, a tap, a slide on the screen of the terminal, an input from a user interface displayed on the terminal, a voice instruction, or a movement (such as a shake) of the terminal. A user-triggered location determination may help reduce terminal power consumption, as the location detection is on a per request basis. As an example, when the user enters a Starbucks store, she/he may trigger a location acquisition, so the terminal may determine the current location as a one-time effort.

402. Determine, based on the current location information, a candidate app installed in the terminal, where an applicable location of the candidate app matches the current location, and the candidate app is a candidate to be selected and used by a user of the terminal.

For example, based on the current location, the terminal determines that the terminal is in a Starbucks store location (i.e., current location matches a Starbucks location), and the Starbucks app is installed in the terminal. Therefore, the terminal may determine that the Starbucks app is a candidate app.

In some example implementations, the determination may be performed locally in the scope of the terminal. The terminal may first determine a list of points of interest based on the current location. For example, based on the current location, the terminal may determine that the points of interest include a Starbucks store, as there is a Starbucks store at the current location. The terminal may then determine that the Starbucks app is a candidate app.

Note that multiple points of interest may be associated with a current location. For example, when the current location is in a shopping mall, a plaza, or an office complex, the points of interest may include a Starbucks store, a Macy's department store, and a Nike store.

In some example implementations, the determination may be performed by the terminal in collaboration with a server. For example, the terminal may transmit current location information to the server by sending a message, to request the list of points of interest. The server, based on the current location information, determines the list of points of interest, and returns the list back to the terminal using a response message. The terminal may then determine the candidate apps based on the list of points of interest returned from the server.

In some example implementations, the terminal may transmit current location information to the server, to request the candidate apps from the server. The server may maintain a database, and is capable of looking up candidate apps from the database by using the current location information. The server may then return the candidate apps to the terminal.

403. Optionally, the terminal may further determine a list of supplementary apps (or list of relevant apps), where each app in the list of supplementary apps is associated with the candidate app and is also a candidate to be used by the user at the current location; or each app in the list of supplementary apps is relevant to the candidate app.

For example, when a user enters a Starbucks store, the Starbucks app may be determined as a candidate app. In addition to the Starbucks app, the user may also use some other apps while in the Starbucks store. For example, the user may use a music app (e.g., Spotify) to listen to music, a video streaming app (e.g., Netflix) to watch videos, and/or a book reading app (e.g., Kindle) to read books. In this sense, these supplemental apps are also relevant to a location.

In this disclosure, the apps relevant to a location may also be referred to as location matched apps. Using the example above, the Starbucks app, the Spotify app, the Netflix app, and the Kindle app are all examples of location matched apps.

404. Populate (add) the candidate app and apps from the list of supplementary/relevant apps to the special app folder.

Once the terminal acquires candidate app and the list of supplementary/relevant apps that the user may use at the current location, the terminal may add these to the special app folder, so the user can easily access the apps relevant to the current location. Note that adding the candidate app and the list of supplementary/relevant apps does not need user intervention, and the addition process is location awareness.

Turning back to FIG. 3, a detailed use case scenario is described herein for explanation purpose. Note that the same principle applies to other use cases as well. Once a user enters a Starbucks store, the terminal (e.g., smartphone) may determine the current location (e.g., spontaneously or triggered by the user). Based on the current location, the terminal may determine that the point of interest is Starbucks, therefore the candidate app may include the Starbucks app 312.

Optionally, the terminal may further determine a list of supplemental/relevant apps associated with the candidate app, either locally, or with the help from a server which may be located at a remote location. For example, as shown in FIG. 3, once the Starbucks app is determined as a candidate app, one or more of following supplemental apps may be determined as being associated with and supplemental to the Starbucks app: a music app (e.g., Spotify) for playing music while the user is in the Starbucks store, a payment app (e.g., Apple pay or Google pay) for paying the bill, a video streaming app (e.g., Netflix) for streaming video while the user is in the Starbucks store, a book reading app (e.g., Kindle) for reading books, and a social media app (e.g., Facebook) for browsing social media news. The terminal then populates the special app folder with the Starbucks app (which is determined as the candidate app), together with the list of supplementary/relevant apps, to support easy user access.

In some example implementations, the determination of supplemental apps to the candidate app may be based on a user profile, which may include at least one of: user age, user gender, user occupation, user's hobby, user's lifestyle, user's interest such as what the user follows at social media.

Alternatively or additionally, a current time may also impact the selection of supplemental apps. For example, if the current time is a morning of a day, then a book reading app may be selected (e.g., user has a habit of reading in the morning time). If the current time is noon, a payment app (e.g., for paying lunch bill), or a music app may be selected. Therefore, the determination of supplemental apps to the candidate app may be based on a current time, or an app usage pattern at the current time.

Alternatively or additionally, the determination of supplemental apps may be based on historical data, such as user's app selection in last n visits to a same location, or a same type of point of interest, where n is a positive integer. For example, when current location is a Starbucks store, only if the user used a music app while in a Starbucks store (at this same location or a different location) in last n visits, then the music app may be determined as a supplemental app to the Starbucks app.

In some example implementations, a predefined or configurable threshold may be used, such that the terminal will determine an app to be a supplemental app only when a usage ratio of this app is greater than or equal to this threshold during the last n visits, n being a positive integer that may be predefined and configurable by the user. For example, the terminal may determine that a music app is a supplementary app only when this music app is used 6 or more times out of the last 10 visits (i.e., threshold is 60%, or 0.6).

In some example implementations, a user may visit a location that has multiple points of interest. For example, when the user visits a shopping mall, or a business complex, then there may be multiple points of interest: a retail store such as Macy's, a coffee shop such as Starbucks, a restaurant such as Panera Bread, or California Pizza Kitchen, a sport apparel store such as Nike or Adidas. In such a crowdy location, the search range for a location match may be further defined. For example, when matching a current location to a point of interest, the search range may be limited to a predefined radius, such as 100 feet, 200 feet, or 500 feet. The predefined radius may be adjustable by the user. For example, to limit the number of points of interest, the user may set the search radius to 50 feet, or 20 feet.

In some example implementations, when the current location matches to multiple points of interest, the terminal may discover multiple candidate apps. The terminal may sort the list of supplementary apps based on a sorting criteria. For example, the terminal may sort the supplemental apps based on a distance of the point of interest associated with the supplemental apps from the user. The point of interest closest to the user is listed first, and the point of interest farthest from the user list listed last.

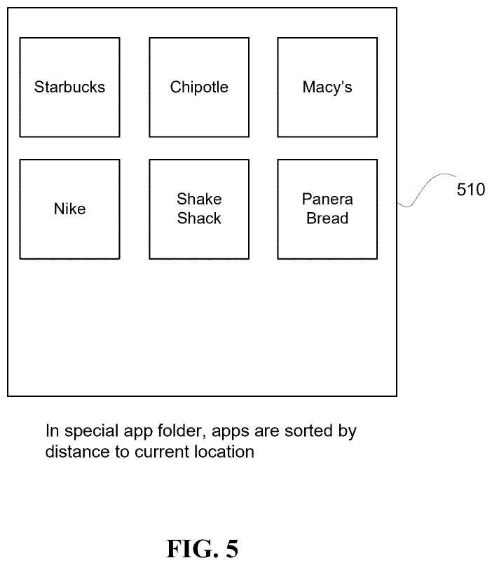

FIG. 5 shows an example for sorted candidate apps. The user is in a Starbucks store in a shopping mall which hosts many other stores. In this case, the terminal may discover multiple candidate apps. Based on a distance to the user from closest to furthest, the terminal may sort these candidate apps as following: the Starbucks app, the Chipotle app, the Macy's app, the Nike app, the Shake Shack app, and the Panera Bread app.

In some example implementations, for one or more apps installed, the terminal may maintain a list supplemental apps which are associated with and supplemental to the one or more apps. The terminal may create and/or update the list whenever a new app is installed.

In some example implementations, for each point of interest the user visited, the terminal may maintain a list of apps that the users used during the visit, and store the list via, for example, a persistent file. The terminal may save the file in a suitable format according to the Operating System (OS) running in the terminal. In some example implementations, the saved file may be encrypted.

In some example implementations, when the user visit a same location, the terminal may read the file saved, and obtain the candidate apps and supplemental apps that were populated last time, and add these apps into the special app folder.

In some example implementations, once the user leaves a location (such as the Starbucks store), the terminal may detect the location change, and clean up the special app folder by removing the Starbucks app from it. A distance between two locations may be used, such that when the distance is greater than a distance threshold, the terminal may determine that the user has moved, and the previously determined candidate app and supplemental apps are obsolete and need to be removed from the special app folder.

In some example implementations, once the user moves to a location that is different from the current location

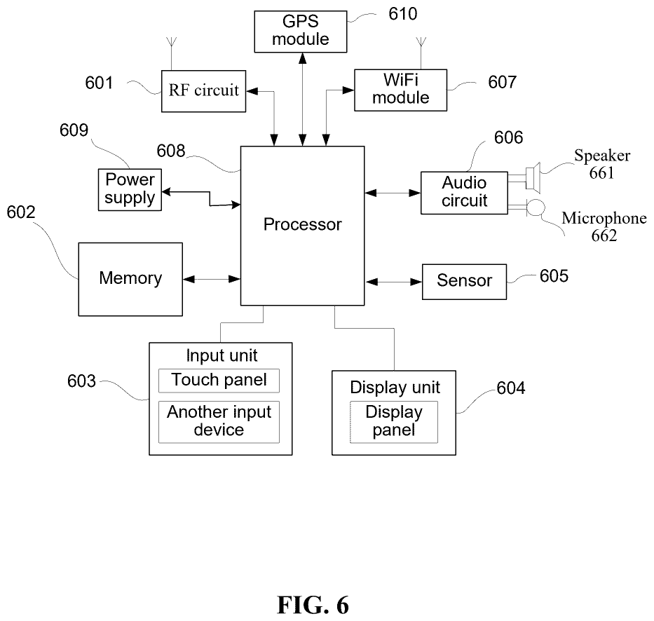

Another embodiment of this disclosure further provides a terminal, a computer device, such as a smartphone, a tablet, a laptop, and the like. As shown in FIG. 6, the terminal may include components such as a radio frequency (RF) circuit 601, a memory 602 including one or more computer-readable non-transitory storage media, an input unit 603, a display unit 604, a sensor 605, an audio circuit 606, a Wireless Fidelity (WiFi) module 607, a processor 608 including one or more processing cores, a power supply 609, and a GPS module 610. A person skilled in the art may understand that, a terminal structure shown in FIG. 6 does not constitute a limitation to the terminal, and the terminal may include more or fewer components than those shown in the figure, or some components may be combined, or a different component deployment may be used.

The RF circuit 601 may be configured to receive and transmit signals in an information receiving and transmitting process or a call process. Specifically, after receiving downlink information from a base station, the RF circuit delivers the downlink information to one or more processors 608 for processing, and transmits related uplink data to the base station. Generally, the RF circuit 601 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 601 may also communicate with a network and another device by wireless communication. The wireless communication may use any communication standard or protocol, which includes, but is not limited to, Global system for mobile communications (GSM), general packet radio service (GPRS), Code Division Multiple Access (CDMA), Wideband Code Division Multiple Access (WCDMA), Long Term Evolution (LTE), 5G New Radio (NR), future generation of wireless communications, email, Short Messaging Service (SMS), and the like.

The memory 602 may be configured to store a software program and a module. The processor 608 runs the software program and the module stored in the memory 602, to perform various functional applications and data processing. The memory 602 may mainly include a program storage area and a data storage area. The program storage area may store an operating system, an application program required by at least one function (such as a sound playback function and an image display function), and the like. The program storage area may store data (such as audio data and an address book) created according to the use of the terminal, and the like. In addition, the memory 602 may include a high-speed random access memory, and may further include a non-volatile memory, such as at least one magnetic disk storage device, a flash memory, or another volatile solid-state storage device. Correspondingly, the memory 602 may further include a memory controller, so as allow the processor 608 and the input unit 603 to access the memory 602.

The input unit 603 may be configured to receive input digit or character information, and generate a keyboard, mouse, joystick, optical, or track ball signal input related to a user setting and function control. Specifically, in a specific embodiment, the input device 603 may include a touch-sensitive surface and another input device. The touch-sensitive surface, also known as a touchscreen or a touch panel, may collect a touch operation of a user on or near the touch-sensitive surface (such as an operation of a user on or near the touch-sensitive surface by using any suitable object or accessory, such as a finger or a stylus), and drive a corresponding connection apparatus according to a preset program. Optionally, the touch-sensitive surface may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and transmits the touch point coordinates to the processor 608. Moreover, the touch controller may receive and execute a command transmitted from the processor 608. In addition, the touch-sensitive surface may be a resistive, capacitive, infrared, or surface acoustic wave typed touch-sensitive surface. In addition to the touch-sensitive surface, the input unit 603 may further include another input device. Specifically, the another input device may include, but is not limited to, one or more of a physical keyboard, a functional key (such as a volume control key or a switch key), a track ball, a mouse, a joystick, and the like.

The display unit 604 may be configured to display information inputted by the user or information provided for the user, and various graphical user interfaces of the terminal. The graphical user interfaces may include a graph, a text, an icon, a video, and any combination thereof. The display unit 604 may include a display panel. Optionally, the display panel may be configured by using a liquid crystal display (LCD), an organic light-emitting diode (OLED), or the like. Further, the touch-sensitive surface may cover the display panel. After detecting a touch operation on or near the touch-sensitive surface, the touch-sensitive surface transfers the touch operation to the processor 608, so as to determine a type of the touch event. Then, the processor 608 provides a corresponding visual output on the display panel according to the type of the touch event. Although in FIG. 6, the touch-sensitive surface and the display panel are used as two separate parts to implement input and output functions, in some embodiments, the touch-sensitive surface and the display panel may be integrated to implement the input and output functions.

The terminal may further include at least one sensor 605, for example, an optical sensor, a motion sensor, and another sensor. Specifically, the optical sensor may include an ambient light sensor and a proximity sensor. The ambient light sensor may adjust luminance of the display panel according to brightness of the ambient light. The proximity sensor may switch off the display panel and/or backlight when the terminal is moved to ears. As one type of motion sensor, a gravity acceleration sensor may detect magnitude of accelerations at various directions (generally on three axes), may detect magnitude and a direction of the gravity when static, and may be applied to an application that recognizes the attitude of the mobile phone (for example, switching between landscape orientation and portrait orientation, a related game, and magnetometer attitude calibration), a function related to vibration recognition (such as a pedometer and a knock), and the like. Other sensors, such as a gyroscope, a barometer, a hygrometer, a thermometer, and an infrared sensor, which may be configured in the terminal, are not described herein again.

The audio circuit 606, a speaker 661, and a microphone 662 may provide audio interfaces between the user and the terminal. The audio circuit 606 may convert received audio data into an electric signal and transmit the electric signal to the speaker. The speaker converts the electric signal into a sound signal for output. On the other hand, the microphone converts a collected sound signal into an electric signal. The audio circuit 606 receives the electric signal and converts the electric signal into audio data, and outputs the audio data to the processor 608 for processing. Then, the processor transmits the audio data to, for example, another terminal by using the RF circuit 601, or outputs the audio data to the memory 602 for further processing. The audio circuit 606 may further include an earplug jack, so as to provide communication between a peripheral earphone and the terminal.

WiFi is a short distance wireless transmission technology. The terminal may help, by using a WiFi module 607, the user to receive and transmit emails, browse webpages, access stream media, and the like, which provides wireless broadband Internet access for the user. Although FIG. 6 shows the WiFi module 607, it may be understood that the WiFi module is not a necessary component of the terminal, and the Wi-Fi module may be omitted as required as long as the scope of the essence of this disclosure is not changed.

The processor 608 is a control center of the terminal, and is connected to various parts of the mobile phone by using various interfaces and lines. By running or executing the software program and/or module stored in the memory 602, and invoking data stored in the memory 602, the processor performs various functions and data processing of the terminal, thereby performing overall monitoring on the mobile phone. Optionally, the processor 608 may include one or more processing cores. Preferably, the processor 608 may integrate an application processor and a modem processor. The application processor mainly processes an operating system, a user interface, an application, and the like. The modem processor mainly processes wireless communication. It may be understood that the foregoing modem may either not be integrated into the processor 608.

The terminal further includes the power supply 609 (such as a battery) for supplying power to the components. Preferably, the power supply may logically connect to the processor 608 by using a power supply management system, thereby implementing functions, such as charging, discharging, and power consumption management, by using the power supply management system. The power supply 609 may further include one or more of a direct current or alternate current power supply, a re-charging system, a power supply failure detection circuit, a power supply converter or inverter, a power supply state indicator, or any other component.

Although not shown in the figure, the terminal may further include a camera, a Bluetooth module, and the like. Details are not described herein again. Specifically, in this embodiment, the processor 608 in the terminal may load executable files corresponding processes of the one or more application programs to the memory 602 according to the following instructions, and runs the application programs stored in the memory 602, so as to implement various functions: determining a current location information indicating a current location of the terminal; determining, based on the current location information, a candidate app installed in the terminal, wherein an applicable location of the app matches the current location, and wherein the candidate app is a candidate to be selected by a user of the terminal; and adding the candidate app to a special app folder which is created in the terminal.

For specific implementation of the above operations, refer to the foregoing embodiments, and details are not described herein again.

The non-transitory storage medium may include: a read-only memory (ROM), a random access memory (RAM), a magnetic disk, an optical disc, or the like.

The instructions stored in the non-transitory storage medium may perform the steps of any method for managing apps installed in a terminal according to the embodiments of this disclosure. For details, refer to the foregoing embodiments. Details are not described herein again.

The method, apparatus, and storage medium for managing apps installed in a terminal according to the embodiments of this disclosure are described in detail above. The principle and implementations of this disclosure are described herein by using specific embodiments. The descriptions of the embodiments are merely used for helping understand the method and the core idea of this disclosure. In addition, a person skilled in the art can make modifications to this disclosure in terms of the specific implementations and application scopes according to the idea of this disclosure. In conclusion, the content of the specification shall not be construed as a limitation to this disclosure.

What is claimed is:

1. A method for managing applications (apps) installed in a terminal, comprising:
determining a current location information indicating a current location of the terminal;
determining, based on the current location information, a candidate app installed in the terminal, wherein an applicable location of the app matches the current location, and wherein the candidate app is a candidate to be selected by a user of the terminal; and
adding the candidate app to a special app folder which is created in the terminal.

2. The method of claim 1, wherein determining the current location information of the terminal comprises:
receiving a triggering instruction to trigger the terminal to determine the current location information; and
in response to the triggering instruction, determining the current location information of the terminal.

3. The method of claim 1, wherein a display position of the special app folder is predefined or configured by the user, and wherein the display position is in a first screen that is shown right after the terminal is unlocked.

4. The method of claim 1, wherein determining the candidate app comprises:
retrieving points of interest based on the current location information, wherein a location of each of the points of interest matches the current location information, and wherein the points of interest comprises at least one of: a grocery store; a retail store; a restaurant; a coffee shop; a library; a hotel; a bank; a gas station; or a gym;
determining whether an app installed in the terminal is associated with the points of interest; and
in response to the app installed in the terminal being associated with the points of interest, determining the app to be the candidate app.

5. The method of claim 4, wherein retrieving the points of interest comprises:
retrieving the points of interest locally based on: 1) a local configuration or a local database and 2) the current location information.

6. The method of claim 4, wherein retrieving the points of interest comprises:
transmitting, to a remote server, a first message carrying the current location information; and
receiving, from the remote server, a response to the first message carrying the points of interest.

7. The method of claim 1, wherein determining the candidate app comprises:
transmitting, to a remote server, a second message carrying the current location information; and
receiving, from the remote server, a response to the second message carrying the candidate app.

8. The method of claim 1, wherein, after determining the candidate app, the method further comprises:
determining a list of supplementary apps, wherein each app in the list of supplementary apps is associated with the candidate app and is a candidate to be used by the user at the current location; and
adding the list of supplementary apps to the special app folder.

9. The method of claim 8, wherein the list of supplementary apps comprises at least one of following apps as the candidate to be used at the current location:
a payment app for making a payment;
a music app for playing music;
a video streaming app for streaming video;
a social media app; or
a book reading app.

10. The method of claim 8, wherein determining the list of supplementary apps comprises determining the list of supplementary apps based one at least one of: an age of the user; a gender of the user; an occupation of the user; a hobby of the user; a lifestyle of the user; an interest of the user;
or a current time.

11. The method of claim 8, wherein determining the list of supplementary apps comprises:
determining a first app that the user used in last n visits to the current location, n being an integer; and
adding the first app to the list of supplementary apps.

12. The method of claim 8, further comprising filtering the list of supplementary apps by removing a first app from the list that satisfy at least one of following condition:
the first app was not used by the user in last n visits to a same location as the current location, n being an integer; or
a usage ratio of the first app in last m visits to the same location as the current location is below a usage ratio threshold, wherein m is an integer, and wherein the usage ratio is predefined, or configured by the user.

13. The method of claim 1, further comprising:
in a determination that the terminal moves to a location different from the current location, or to a location with a distance from the current location great than a distance threshold, removing the candidate app from the special app folder, wherein the distance threshold is predefined or configurable.

14. A device for managing applications (apps) its installed apps, comprising a memory for storing computer readable instructions and a processor in communication with the memory, wherein the processor is configured to execute the computer readable instructions to cause the device to:
determine a current location information indicating a current location of the device;
determine, based on the current location information, a candidate app installed in the device, wherein an applicable location of the app matches the current location, and wherein the candidate app is a candidate to be selected by a user of the device; and
add the candidate app to a special app folder which is created in the device.

15. The device of claim 14, wherein, when the processor is configured to cause the device to determine the current location information of the device, the processor is configured to cause the device to:
receive a triggering instruction to trigger the device to determine the current location information; and
in response to the triggering instruction, determine the current location information of the device.

16. The device of claim 14, wherein a display position of the special app folder is predefined or configured by the user, and wherein the display position is in a first screen that is shown right after the device is unlocked.

17. The device of claim 14, wherein, when the processor is configured to cause the device to determine the candidate app, the processor is configured to cause the device to:
retrieve points of interest based on the current location information, wherein a location of each of the points of interest matches the current location information, and wherein the points of interest comprises at least one of: a grocery store; a retail store; a restaurant; a coffee shop; a library; a hotel; a bank; a gas station; or a gym;
determine whether an app installed in the device is associated with the points of interest; and
in response to the app installed in the device being associated with the points of interest, determine the app to be the candidate app.

18. The device of claim 17, wherein, when the processor is configured to cause the device to retrieve the points of interest, the processor is configured to cause the device to:
retrieve the points of interest locally based on: 1) a local configuration or a local database and 2) the current location information.

19. The device of claim 17, wherein, when the processor is configured to cause the device to retrieve the points of interest, the processor is configured to cause the device to:
transmit, to a remote server, a first message carrying the current location information; and
receive, from the remote server, a response to the first message carrying the points of interest.

20. A non-transitory storage medium for storing computer readable instructions, the computer readable instructions, when executed by a processor in a device, causing the processor to:
determine a current location information indicating a current location of the device;
determine, based on the current location information, a candidate app installed in the device, wherein an applicable location of the app matches the current location, and wherein the candidate app is a candidate to be selected by a user of the device; and
add the candidate app to a special app folder which is created in the device.
